(19) United States
(12) Patent Application Publication
(10) Pub. No.: US 2008/0236832 A1
(43) Pub. Date: Oct. 2, 2008

(54) Method for Treating Subterranean Formation

(76) Inventors: Diankui Fu, Tyumen (RU); Dmitri Oussoltsev, Novosibirsk (RU); Artem Klyubin, Tambov (RU); Olesya Levanyuk, Tyumen City (RU); Kreso Kurt Butula, Zagreb (HR)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/691,099

(22) Filed: Mar. 26, 2007

(51) Int. Cl. E21B 43/267; C09K 8/00

(52) U.S. Cl. 166/308.2

(57) ABSTRACT

A method is for treating a subterranean formation penetrated by a wellbore is given which comprises injecting into the subterranean formation a well treatment fluid having a high pH. The well treatment fluid comprises a viscoelastic surfactant having a degradable linkage, a hydrolysable fiber and a pH control material

### FIELD OF THE INVENTION

The present invention relates to the art of treating subterranean formations and more particularly, to a method of delivering a fluid treatment composition with high pH and a degradable fiber into a formation. The invention is particularly applicable to methods of delivering low viscosity viscoelastic surfactant compositions that are capable of transporting large size proppants but break cleanly without the need for pre flushes or post flushes.

### BACKGROUND OF THE INVENTION

Hydraulic fracturing of subterranean formations has long been established as an effective means to stimulate the production of hydrocarbon fluids from a wellbore. In hydraulic fracturing, a well stimulation fluid (generally referred to as a fracturing fluid) is injected into and through a wellbore and against the surface of a subterranean formation penetrated by the wellbore at a pressure at least sufficient to create a fracture in the formation. Usually a “pad fluid” is injected first to create the fracture and then a fracturing fluid, often bearing granular propping agents, is injected at a pressure and rate sufficient to extend the fracture from the wellbore deeper into the formation. If a proppant is employed, the goal is generally to create a proppant filled zone from the tip of the fracture back to the wellbore. In any event, the hydraulically induced fracture is more permeable than the formation and it acts as a pathway or conduit for the hydrocarbon fluids in the formation to flow to the wellbore and then to the surface where they are collected.

The fluids used as fracturing fluids have also been varied, but many if not most are aqueous based fluids that have been “viscosified” or thickened by the addition of a natural or synthetic polymer (crosslinked or uncrosslinked) or a viscoelastic surfactant (VES). The carrier fluid is usually water or a brine (e.g., dilute aqueous solutions of sodium chloride and/or potassium chloride).

The viscosifying polymer is typically a solvatable (or hydratable) polysaccharide, such as a galactomannan gum, a glycomannan gum, or a cellulose derivative. Examples of such polymers include guar, hydroxypropyl guar, carboxymethyl guar, carboxymethylhydroxyethyl guar, hydroxyethyl cellulose, carboxymethylhydroxyethyl cellulose, hydroxypropyl cellulose, xanthan, polyacrylamides and other synthetic polymers. Of these, guar, hydroxypropyl guar and carboxymethylhydroxypropyl guar are typically preferred because of commercial availability and cost performance.

In many instances, if not most, the viscosifying polymer is crosslinked with a suitable crosslinking agent. The crosslinked polymer has an even higher viscosity and is even more effective at carrying proppant into the fractured formation. The borate ion has been used extensively as a crosslinking agent, typically in high pH fluids, for guar, guar derivatives and other galactomannans. Other crosslinking agents include, for example, titanium, chromium, iron, aluminum, and zirconium.

Viscoelastic surfactant fluids are normally made by mixing into the carrier fluid appropriate amounts of suitable surfactants such as anionic, cationic, nonionic and zwitterionic surfactants. The viscosity of viscoelastic surfactant fluids is attributed to the three dimensional structure formed by the components in the fluids. When the concentration of viscoelastic surfactants significantly exceeds a critical concentration, surfactant molecules aggregate into micelles, which can become highly entangled to form a network exhibiting elastic behavior.

Viscoelastic surfactant solutions are usually formed by the addition of certain reagents to concentrated solutions of surfactants, frequently consisting of long-chain quaternary ammonium salts such as cetyltrimethylammonium bromide (CTAB). Common reagents that generate viscoelasticity in the surfactant solutions are salts such as ammonium chloride, potassium chloride, sodium salicylate and sodium isocyanate and non-ionic organic molecules such as chloroform. The electrolyte content of surfactant solutions is also an important control on their viscoelastic behavior.

During hydraulic fracturing treatments, control of fracture height growth can be an important issue. In situations where the water table is close to the fracturing zone, or where the fracture zones have low stress barriers, where fracture height growth can result in screen outs, control of the fracture height may be critical. A common technique for the control of fracture height control is to use fluids with lower viscosity, such as VES surfactants. Lower viscosity fluids however, do not transport the large sized proppants effectively in the fracture.

One method of addressing the issue has been the incorporation of fiber into the surfactant fluids. However, the breaking of fiber and of fiber bearing VES fracturing fluid can be still be problematic especially without pre or post flushes. It would be helpful to have a VES fluid which would transport the large sized proppants effectively and still break under low temperature conditions, leaving little or no residue solids in the fracture.

The need for improved well services fluids still exists, and the need is met at least in part by the following invention.

### SUMMARY OF THE INVENTION

In one embodiment, the invention provides a method for treating a subterranean formation penetrated by a wellbore which comprises injecting into the subterranean formation a well treatment fluid having a high pH comprising a viscoelastic surfactant and a degradable fiber, wherein the fluid has an initial pH of at least about 10.

In another embodiment, the invention provides a method for treating a subterranean formation penetrated by a wellbore which comprises injecting into the subterranean formation a well treatment fluid having a high pH comprising a viscoelastic surfactant, a hydrolysable fiber and a pH control material, wherein said viscoelastic surfactant and said hydrolysable fiber undergo hydrolysis in a high pH environment.

In another embodiment, the invention provides a method for treating a subterranean formation penetrated by a wellbore which comprises injecting into the subterranean formation a well treatment fluid comprising a viscoelastic surfactant, a hydrolysable fiber and a pH control material, wherein said viscoelastic surfactant and said hydrolysable fiber undergo hydrolysis in a high pH environment to form non-solid materials.

In another embodiment, the invention provides a method for treating a subterranean formation penetrated by a wellbore which comprises injecting into the subterranean formation a well treatment fluid comprising a viscoelastic surfactant, a hydrolysable fiber and a pH control material, wherein said pH control material creates an initial fluid pH of at least about 10, wherein said viscoelastic surfactant and said hydrolysable fiber undergo hydrolysis.

In another embodiment, the invention provides a fluid composition comprising a viscoelastic surfactant and a degradable fiber.

In yet another embodiment, the inventions provides a viscoelastic surfactant and a hydrolysable fiber and a pH control material, wherein said viscoelastic surfactant and said hydrolysable fiber undergo hydrolysis in a high pH environment.

Unless otherwise specifically stated, all percentages herein are percentages by weight

### BRIEF DESCRIPTION OF THE DRAWINGS

FIG. 1 is a graph plotting viscosity of a fluid solution over time in hours at 80° C.

FIG. 2 is a graph plotting viscosity of a fluid solution over time in hours at 100° C.

### DETAILED DESCRIPTION OF THE INVENTION

A first embodiment of the invention is an oilfield treatment method including providing a fluid viscosified with a viscoelastic surfactant, and including a degradable fiber.

Useful degradable fibers may be those degraded by various schemes. In one embodiment, the degradable fiber is a hydrolysable fiber. Hydrolysis is a chemical reaction in which water reacts with another compound to form two or more substances. Certain types of fiber forming compounds will hydrolyze into non-solid compounds which may easily be removed from the formation. Use of such fibers may also have additional benefits such as fluid diversion and the control of undesirable fluid loss.

In one embodiment, the method of the invention employs fiber when exposed to high pH conditions for a period of time. Examples of such fibers include, but are not limited to polyesters, polyamides, polylactides and the like.

In one embodiment, the method of the invention employs polylactic acid, which undergoes a hydrolysis to form a liquid when exposed to a high pH environment as shown in the following reaction scheme:

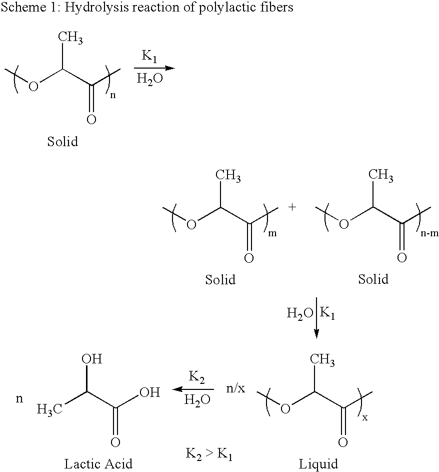

In order to provide a pH environment suitable for the hydrolysis of the fiber to occur, a pH control agent may be included in the fluid. Useful pH control agents will vary with the specific degradable fiber selected for use, but generally may include those agents which are strongly alkaline materials that may provide a high pH environment. Generally, pH control agents having a pH of 9 or more are considered to be strongly alkaline materials. Examples of such pH control agents include, but are not limited to, metal hydroxides, metal oxides, calcium hydroxide, metal carbonates or bicarbonates, and the like.

The pH control material provides a high pH fluid environment, typically the fluid has an initial pH of at least about 10 at temperature of about 80° C., in many embodiments the initial pH is from about 11 to about 13. The initial pH is typically higher if the temperature is higher, e.g., at 100° C., the typical initial pH is at least about 11, typically from about 12 to about 14. The high pH environment persists well, keeping the pH above about 10 after three hours, and a pH of at least about 9 after more than ten hours. The term “pH’ is defined as the logarithm of the reciprocal of the hydrogen-ion concentration of a solution. It is to be understand that pH values are traditionally measured on a scale from 1 to 14, so that when a pH value is identified by only a minimum or maximum value that the opposite end of the range is dictated by the pH range of 1-14. For example, a material having a pH of at least 9 could also be described as a material having a pH in the range of from about 9 to about 14.

The amount of pH control agent required to provide such a high pH environment will vary with the particular control agent selected and with the system, but generally, the pH control agent may comprise from about 0.5 weight percent to about 15 weight percent of the treatment fluid. In one embodiment, the fluid may contain from about 1 weight percent to about 10 weight percent. In another embodiment, the fluid may contain about 3 weight percent to about 10 weight percent. In yet another embodiment, the fluid may contain from about 3 weight percent to about 7 weight percent.

When fluids are viscosified by the addition of viscoelastic surfactant systems, the viscosity increase is believed to be due to the formation of micelles, for example worm-like micelles, which entangle to give structure to the fluid that leads to the viscosity. In addition to the viscosity itself, an important aspect of a fluid's properties is the degree of viscosity-recovery or re-healing when the fluid is subjected to high shear and the shear is then reduced. For VES fluids, shear may disrupt the micelle structure, after which the structure reforms. Controlling the degree of reassembling (re-healing) is necessary to maximize performance of the surfactant system for different applications. For example, in hydraulic fracturing it is critical for the fluid to regain viscosity as quickly as possible after exiting the high-shear region in the tubulars and entering the low-shear environment in the hydraulic fracture. On the other hand, it is beneficial in coiled tubing cleanouts to impart a slight delay in regaining full viscosity in order to “jet” the solids more efficiently from the bottom of the wellbore into the annulus. Once in the annulus the regained viscosity ensures that the solids are effectively transported to the surface. Controlling the viscosity-recovery and the time required for such recovery is therefore desirable.

Many viscoelastic surfactants may be used in this application. Surfactants with a degradable linkage in the molecule will hydrolyse to separate the hydrophilic head and the hydrophobic tail. While not wishing to be bound by theory, it is believed that such separation will degrade the micelles formed by the VES surfactant.

Exemplary cationic viscoelastic surfactants include the amine salts and quaternary amine salts disclosed in U.S. Pat. Nos. 5,979,557, and 6,435,277 which have a common Assignee as the present application and which are hereby incorporated by reference.

In one embodiment, the viscoelastic surfactant has an amide linkage in the head group, according to the scheme

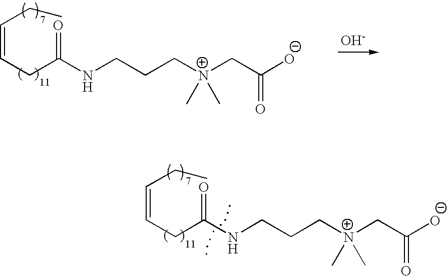

XX Examples of suitable cationic viscoelastic surfactants include cationic surfactants having the structure:

R₁N⁺(R₂)(R₃)(R₄) X⁻

in which R₁ has from about 14 to about 26 carbon atoms and may be branched or straight chained, aromatic, saturated or unsaturated, and may contain a carbonyl, an amide, a retroamide, an imide, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms. Cationic surfactants having the structure R₁N⁺(R₂)(R₃)(R₄)X⁻ may optionally contain amines having the structure R₁N(R₂)(R₃). It is well known that commercially available cationic quaternary amine surfactants often contain the corresponding amines (in which R₁, R₂, and R₃ in the cationic surfactant and in the amine have the same structure). As received commercially available VES surfactant concentrate formulations, for example cationic VES surfactant formulations, may also optionally contain one or more members of the group consisting of solvents, mutual solvents, organic acids, organic acid salts, inorganic salts, and oligomers, polymers, co-polymers, and mixtures of these members. They may also contain performance enhancers, such as viscosity enhancers, for example polysulfonates, for example polysulfonic acids, as described in copending U.S. Patent Application Publication No. 2003-0134751 which has a common Assignee as the present application and which is hereby incorporated by reference.

Another suitable cationic VES is erucyl bis(2-hydroxyethyl) methyl ammonium chloride, (“EMHAC”), also known as (Z)-13 docosenyl-N—N— bis(2-hydroxyethyl) methyl ammonium chloride. It is commonly obtained from manufacturers as a mixture containing about 60 weight percent surfactant in a mixture of iso-propanol, ethylene glycol and water. In this patent, when we refer to “EMHAC” we mean such a solution. Other suitable amine salts and quaternary amine salts include (either alone or in combination in accordance with the invention), erucyl trimethyl ammonium chloride; N-methyl-N,N-bis(2-hydroxyethyl) rapeseed ammonium chloride; oleyl methyl bis(hydroxyethyl) ammonium chloride; erucylamidopropyltrimethylamine chloride, octadecyl methyl bis(hydroxyethyl) ammonium bromide; octadecyl tris(hydroxyethyl) ammonium bromide; octadecyl dimethyl hydroxyethyl ammonium bromide; cetyl dimethyl hydroxyethyl ammonium bromide; cetyl methyl bis(hydroxyethyl) ammonium salicylate; cetyl methyl bis(hydroxyethyl) ammonium 3,4,-dichlorobenzoate; cetyl tris(hydroxyethyl) ammonium iodide; cosyl dimethyl hydroxyethyl ammonium bromide; cosyl methyl bis(hydroxyethyl) ammonium chloride; cosyl tris(hydroxyethyl) ammonium bromide; dicosyl dimethyl hydroxyethyl ammonium bromide; dicosyl methyl bis(hydroxyethyl) ammonium chloride; dicosyl tris(hydroxyethyl) ammonium bromide; hexadecyl ethyl bis(hydroxyethyl) ammonium chloride; hexadecyl isopropyl bis(hydroxyethyl) ammonium iodide; and cetylamino, N-octadecyl pyridinium chloride.

Zwitterionic viscoelastic surfactants are also suitable. Exemplary zwitterionic viscoelastic surfactants include those described in U.S. Pat. No. 6,703,352 which has a common Assignee as the present application and which is hereby incorporated by reference. Exemplary zwitterionic surfactants have the structure:

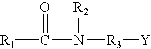

in which R₁ is a hydrocarbyl group that may be branched or straight chained, aromatic, aliphatic or olefinic and contains from about 14 to about 26 carbon atoms and may include an amine; R₂ is hydrogen or an alkyl group having from 1 to about 4 carbon atoms; R₃ is a hydrocarbyl group having from 1 to about 5 carbon atoms; and Y is an electron withdrawing group. More particularly, the zwitterionic surfactant may have the betaine structure:

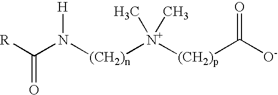

in which R is a hydrocarbyl group that may be branched or straight chained, aromatic, aliphatic or olefinic and has from about 14 to about 26 carbon atoms and may contain an amine; n=about 2 to about 4; and p=1 to about 5. Mixtures of these compounds may also be used.

Two examples of suitable betaines are, respectively, BET-O-30 and BET-E-40. The VES surfactant in BET-O-30 is oleylamidopropyl betaine. It is designated BET-O-30 here, because as obtained from the supplier (Rhodia, Inc. Cranbury, N.J., U.S.A.) it is called Mirataine BET-O-30; it contains an oleyl acid amide group (including a C₁₇H₃₃ alkene tail group) and is supplied as about 30% active surfactant; the remainder is substantially water, sodium chloride, glycerol and propane-1,2-diol. An analogous suitable material, BET-E-40, was used in the experiments described below; one chemical name is erucylamidopropyl betaine. BET-E-40 is also available from Rhodia; it contains a erucic acid amide group (including a C₂₁H₄, alkene tail group) and is supplied as about 40% active ingredient, with the remainder substantially water, sodium chloride, and iso-propanol. BET surfactants, and others that are suitable, are described in U.S. Pat. No. 6,703,352.

Certain co-surfactants may be useful in extending the brine tolerance, to increase the gel strength, to reduce the shear rehealing time, and/or to reduce the shear sensitivity of zwitterionic VES fluid systems, such as betaine VES fluids. An example given in U.S. Pat. No. 6,703,352 is sodium dodecylbenzene sulfonate (SDBS). Another example is polynaphthalene sulfonate. Zwitterionic VES surfactants may be used with or without this type of co-surfactant, for example those having a SDBS-like structure having a saturated or unsaturated, branched or straight-chained C₆ to C₁₆ chain; further examples of this type of co-surfactant are those having a saturated or unsaturated, branched or straight-chained C₈ to C₁₆ chain. Other suitable examples of this type of co-surfactant, especially for BET-O-30, are certain chelating agents such as trisodium hydroxyethylethylenediamine triacetate. Many suitable additives are known for improving the performance of gelled VES surfactant systems; any may be used in the current invention; they should be tested for compatibility with the compositions and methods of the invention before use; simple laboratory experiments for such testing are well known.

Zwitterionic surfactant viscoelastic systems typically contain one or more members of the group consisting of organic acids, organic acid salts, inorganic salts, and oligomers, polymers, co-polymers, and mixtures of these members. This member is typically present in only a minor amount and need not be present at all. The organic acid is typically a sulfonic acid or a carboxylic acid and the anionic counter-ion of the organic acid salts are typically sulfonates or carboxylates. Representative of such organic molecules include various aromatic sulfonates and carboxylates such as p-toluene sulfonate, naphthalene sulfonate, chlorobenzoic acid, salicylic acid, phthalic acid and the like, where such counter-ions are water-soluble. Most preferred are salicylate, phthalate, p-toluene sulfonate, hydroxynaphthalene carboxylates, e.g. 5-hydroxy-1-naphthoic acid, 6-hydroxy-1-naphthoic acid, 7-hydroxy-1-naphthoic acid, 1-hydroxy-2-naphthoic acid, preferably 3-hydroxy-2-naphthoic acid, 5-hydroxy-2-naphthoic acid, 7-hydroxy-2-naphthoic acid, and 1,3-dihydroxy-2-naphthoic acid and 3,4-dichlorobenzoate. The organic acid or salt thereof typically aids the development of increased viscosity that is characteristic of preferred fluids. The organic acid or salt thereof is typically present in the zwitterionic viscoelastic fluid (after the viscoelastic surfactant has concentrated sufficiently to viscosify the fluid) at a weight concentration of from about 0.1% to about 10%, more typically from about 0.1% to about 7%, and even more typically from about 0.1% to about 6%.

Inorganic salts that are particularly suitable for use in the zwitterionic viscoelastic fluid include water-soluble potassium, sodium, and ammonium salts, such as potassium chloride and ammonium chloride. Additionally, calcium chloride, calcium bromide and zinc halide salts may also be used. The inorganic salts may aid in the development of increased viscosity which is characteristic of preferred fluids. Further, the inorganic salt may assist in maintaining the stability of a geologic formation to which the fluid is exposed. Formation stability and in particular clay stability (by inhibiting hydration of the clay) is achieved at a concentration level of a few percent by weight. The inorganic salt is typically present in the zwitterionic viscoelastic fluid (after the viscoelastic surfactant has concentrated sufficiently to viscosify the fluid) at a weight concentration of from about 0.1% to about 30%, more typically from about 0.1% to about 10%, and even more typically from about 0.1% to about 8%. Organic salts, e.g. trimethylammonium hydrochloride and tetramethylammonium chloride, may also be used in addition to, or as a replacement for, the inorganic salts. Optionally, these systems may be formed in dense brines, including brines containing polyvalent cations.

As an alternative to the organic salts and inorganic salts, or as a partial substitute therefore, one can use a medium to long chain alcohol (preferably an alkanol), preferably having five to ten carbon atoms, or an alcohol ethoxylate (preferably an alkanol ethoxylate) preferably of a 12 to 16 carbon alcohol and having 1 to 6, preferably 1-4, oxyethylene units.

Amphoteric viscoelastic surfactants are also suitable. Exemplary amphoteric viscoelastic surfactants include those described in U.S. Pat. No. 6,703,352, for example amine oxides. One useful amine oxide surfactant has the formula:

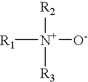

wherein R₁, R₂, and R₃ are independently selected from alkyl, alkenyl, arylalkyl, or hydroxyalkyl groups wherein each of said alkyl groups contain from about 8 to about 24 carbon atoms and may be branched or straight chained and saturated or unsaturated

Mixtures of zwitterionic surfactants and amphoteric surfactants are also suitable. An example, called BET-E-40/AO here, is a mixture of about 13% iso-propanol, about 5% 1-butanol, about 15% ethylene glycol monobutyl ether, about 4% sodium chloride, about 30% water, about 30% cocamidopropyl betaine, and about 2% cocamidopropylamine oxide.

The fluid may be used, for example in oilfield treatments. As examples, the fluid may be used as a pad fluid and as a carrier fluid in hydraulic fracturing, as a carrier fluid for lost circulation control agents, and as a carrier fluid for gravel packing. The fluids may also be used in other industries, such as pharmaceuticals, cosmetics, printing, and agriculture.

The optimal concentration of a given rheology enhancing additive of the invention for a given choice of VES surfactant fluid system at a given concentration and temperature, and with given other materials present, can be determined by simple experiments. The total viscoelastic surfactant concentration must be sufficient to form a viscoelastic gel under conditions at which the surfactants have sufficient aggregation tendency. The appropriate amounts of surfactant and rheology enhancer are those necessary to achieve the desired viscosity and shear recovery time as determined by experiment. Again, tolerance for, and optimal amounts of other additives may also be determined by simple experiment. In general, the amount of surfactant (as active ingredient) is from about 1 to about 10%. Commercially available surfactant concentrates may contain some materials that we have found may be used as rheology enhancers, for example for concentrate freezing point depression, but normally the amount of such material is not sufficient, when the concentrate is diluted, in the final fluid. The amount of rheology enhancer used, in addition to any that may be already present in the as-received surfactant concentrate, is from about 0.1 to about 6%, for example from about 0.25 to about 3.5%, most particularly from about 0.25 to about 1.75%. Mixtures of surfactants and/or mixtures of rheology enhancers may be used.

### EXAMPLES

The present invention can be further understood from the following examples. The examples were tested according to the following procedure:

To a one-liter Waring® blender cup was added 200 ml of 2% potassium chloride (KCl) solution. The indicated amount of sodium hydroxide NaOH was added into the blender cup while blending, followed by the addition of 0.72 gram of polylactic acid fiber.

To the above solution 12 ml of VES solution was added. The VES solution, known as BET-E-40, was used in the experiments; one chemical name is erucylamidopropyl betaine. BET-E-40 is also available from Rhodia; it contains a erucic acid amide group (including a C₂₁H₄, alkene tail group) and is supplied as about 40% active ingredient, with the remainder substantially water, sodium chloride, and iso-propanol. BET surfactants, and others that are suitable, are described in U.S. Pat. No. 6,703,352.

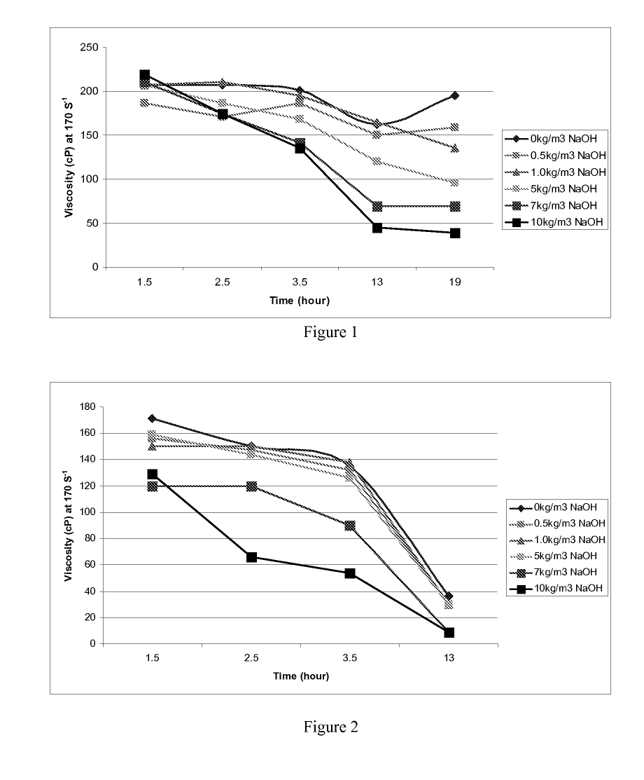

The solution was blended for 3 minutes and then the solution was poured into a 500 ml bottle and closely capped. The capped bottle was then placed into an oven which had been preheated to the test temperature. Samples were taken at desired time intervals starting at 1.5 hours and up to about 19 hours. Viscosity of the samples was measured using a Chandler® 3500 Rheometer at shear rates of 170 S⁻¹ and 511 S⁻¹. One set of samples were measured at a temperature of 80° C. and the data are shown in table 1 and plotted in FIG. 1. The second set of samples were measured at 100° C. and the data are shown in Table 2 and plotted in FIG. 2.

As can be seen, the samples with high pH environment, i.e., those samples having 7% weight percent or more of NaOH, show a viscosity curves indicating hydrolysis to form liquid products, and thus reduce viscosity to below 100 centipoise (cP) at 80° C., and below 20 cP at 100° C.

Fluid pH readings were taken initially and after different intervals. Tables 3 and 4 show that the pH control agent typically yields an initial pH of at least about 10 when the fluid temperature is at 80° C. At 100° C., the initial fluid pH is typically at least about 11. It can be observed that the pH remains high for hours, declining very slowly over time. At both temperatures, the pH starts at or near 12 for fluids having only 0.5 kg/m³ of pH control material, remains above 10 even after 3.5 hours, and remains above 9 even after 15 hours. Fluids with higher initial concentrations of pH control agent remain above 11 after 3.5 hours at either temperature, and remain at or close to 13 hours. Fluids with an initial concentration of 10 kg/m³ actually show an increase in pH after many hours.

FIG. 1 shows a plot of viscosity of the various high pH compositions tested at 80° C. It can be seen, that the fluid composition without a strongly basic pH control material present remains at a viscosity of more than 150 cP for the entire 19 hour testing period, dipping from 200 cP to close to 150 cP at 13 hours and then recovering to nearly 200 cP at 19 hours. The fluid with 0.5 kg/m³ concentration of pH control agent also showed a small increase in viscosity at 19 hours, staying just above 150 cP. The three fluid compositions having higher concentrations of pH control agent, i.e., 1, 5, 7, and 10 kg/m³ respectively, do not show such an increase and exhibit much faster drops in viscosity being less than 150 cP by 3.5 hours, and all exhibit viscosities of less than 100 cP at 19 hours. Clearly, the high pH fluids break down quicker and to lower viscosities at 80° C. than fluid compositions having no pH control agent, or an amount insufficient to sustain a high pH environment throughout the test (note in Table 3 that the pH of the fluid having a 0.5 kg/m³ concentration of pH control agent falls to 9.37 at 13 hours and 8.84 at 19 hours, the time at which the viscosity shows an increase.

FIG. 2 shows a plot of viscosity of the various high pH compositions tested at 100° C. It can be seen that, at the higher temperature, viscosity breakdown is not as sensitive to fluids with lesser concentrations of pH control agent. The fluid composition without a strongly basic pH control material present remains at a viscosity of more than 100 cP for 3.5 hours, falling to show a viscosity of just under 40 cP at the end of the 13 hour testing period. No increase in viscosity is observed in any fluid at the higher temperature. The fluids with 0.5 kg/m³, 1 kg/m³ and 5 kg/m³ concentrations of pH control agent also stayed near just above 150 cP. The two fluid compositions having higher concentrations of pH control agent, i.e., 7, and 10 kg/m³ respectively exhibit much faster drops in viscosity, being less than 100 cP by 3.5 hours (less than 60 cP for the fluid with 10 kg/m³ concentration), and these two exhibit viscosities of less than 20 cP at 13 hours, at which time the test was discontinued.

TABLE 1
Tests temperature 80° C.

| time, | 0 kg/m3 M002 | | 0.5 kg/m3 M002 | | 1.0 kg/m3 M002 | | 5 kg/m3 M002 | | 7.0 kg/m3 M002 | | 10 kg/m3 M002 | |
|---|---|---|---|---|---|---|---|---|---|---|---|---|
| hour | 170 sec−1 | 511 sec−1 | 170 sec−1 | 511 sec−1 | 170 sec−1 | 511 sec−1 | 170 sec−1 | 511 sec−1 | 170 sec−1 | 511 sec−1 | 170 sec−1 | 511 sec−1 |
| 1.5 | 207 | 74 | 186 | 73 | 207 | 80 | 207 | 77 | 210 | 82 | 219 | 80 |
| 2.5 | 207 | 70 | 171 | 66 | 210 | 78 | 186 | 72 | 174 | 70 | 174 | 70 |
| 3.5 | 201 | 68 | 186 | 68 | 195 | 73 | 168 | 60 | 141 | 55 | 135 | 50 |
| 13 | 162 | 68 | 150 | 70 | 165 | 65 | 120 | 55 | 69 | 35 | 45 | 30 |
| 19 | 195 | 68 | 159 | 60 | 135 | 65 | 96 | 50 | 69 | 35 | 39 | 25 |

TABLE 2
Tests temperature 100° C.

| time, | 0 kg/m3 M002 | | 0.5 kg/m3 M002 | | 1.0 kg/m3 M002 | | 5 kg/m3 M002 | | 7.0 kg/m3 M002 | | 10 kg/m3 M002 | |
|---|---|---|---|---|---|---|---|---|---|---|---|---|
| hour | 170 sec−1 | 511 sec−1 | 170 sec−1 | 511 sec−1 | 170 sec−1 | 511 sec−1 | 170 sec−1 | 511 sec−1 | 170 sec−1 | 511 sec−1 | 170 sec−1 | 511 sec−1 |
| 1.5 | 171 | 60 | 156 | 63 | 150 | 63 | 159 | 63 | 120 | 75 | 129 | 50 |
| 2.5 | 150 | 60 | 147 | 58 | 150 | 60 | 144 | 60 | 120 | 55 | 66 | 53 |
| 3.5 | 135 | 57 | 132 | 55 | 138 | 60 | 126 | 50 | 90 | 55 | 54 | 42 |
| 15 | 36 | 15 | 30 | 8 | 30 | 8 | 30 | 8 | 9 | 7 | 9 | 5 |

pH

TABLE 3
Tests temperature 80° C.

| time, | 0 kg/m3 | 0.5 kg/m3 | 1.0 kg/m3 | 5 kg/m3 | 7.0 kg/m3 | 10 kg/m3 |
|---|---|---|---|---|---|---|
| hour | M002 | M002 | M002 | M002 | M002 | M002 |
| 0, at | 8.67 | 12 | 12.25 | 12.72 | 12.79 | 13.56 |
| room | | | | | | |
| temp | | | | | | |
| 1.5 | 7.83 | 10.86 | 10.89 | 11.3 | 11.43 | 11.58 |
| 2.5 | 7.81 | 10.34 | 10.79 | 11.53 | 11.47 | 11.36 |
| 3.5 | 7.88 | 10.58 | 10.89 | 11.43 | 11.53 | 11.64 |
| 13 | 7.73 | 9.37 | 9.84 | 11.2 | 12.05 | 12.16 |
| 19 | 7.68 | 8.84 | 9.7 | 10.98 | 12 | 12.05 |

TABLE 4
Tests temperature 100° C.

| time, | 0 kg/m3 | 0.5 kg/m3 | 1.0 kg/m3 | 5 kg/m3 | 7.0 kg/m3 | 10 kg/m3 |
|---|---|---|---|---|---|---|
| hour | M002 | M002 | M002 | M002 | M002 | M002 |
| 0, at | 6.65 | 11.78 | 11.98 | 12.38 | 12.46 | 13 |
| room | | | | | | |
| temp | | | | | | |
| 1.5 | 7.52 | 10.69 | 11 | 11.48 | 11.56 | 12 |
| 2.5 | 7.7 | 10.45 | 10.73 | 11.23 | 11.42 | 11.57 |
| 3.5 | 7.45 | 10.31 | 10.69 | 11.35 | 11.55 | 11.6 |
| 15 | 7.38 | 9.6 | 10.06 | 11 | 11.83 | 12 |

1. A method for treating a subterranean formation penetrated by a wellbore which comprises injecting into the subterranean formation a high well treatment fluid comprising a viscoelastic surfactant having at least one degradable linkage, a hydrolysable fiber and a pH control material, wherein said hydrolysable fiber and said viscoelastic surfactant and said hydrolysable fiber form non-solid products upon hydrolysis, and wherein said fluid has an initial pH of at least about 10.

2. (canceled)

3. The method of claim 1, wherein said fiber is selected from the group consisting of polyesters, polyamides, and polylactides.

4. (canceled)

5. The method of claim 3, wherein said fiber is polylactic acid or poly(ethyl terephthalate).

6. (canceled)

7. (canceled)

8. (canceled)

9. The method of claim 1, wherein said fluid has an initial has an initial pH of at least about 11.

10. The method of claim 1, wherein said pH control material is selected from the group consisting of metal hydroxides, metal oxides, calcium hydroxide, metal carbonates, and metal bicarbonates.

11. The method of claim 1 wherein said viscoelastic surfactant comprises a cationic surfactant having the structure:
R₁N⁺(R₂)(R₃)(R₄)X⁻
in which R₁ has from about 14 to about 26 carbon atoms and may be branched or straight chained, aromatic, saturated or unsaturated, and may comprise a carbonyl, an amide, a retroamide, an imide, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; and X⁻is an anion; and mixtures of these compounds.

12. (canceled)

13. The method of claim 1 wherein the viscoelastic surfactant is represented by a formula:

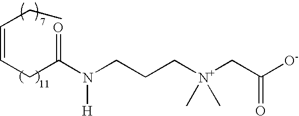

14. The method of claim 1 wherein said viscoelastic surfactant is a zwitterionic surfactant represented by a formula: 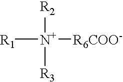
wherein R₁ is an alkyl, alkenyl, arylalkyl, or hydroxyalkyl group wherein each of said alkyl groups contain from about 8 to about 24 carbon atoms and may be branched or straight chained and saturated or unsaturated; and wherein R₂, and R₃ are independently a hydrogen or an aliphatic chain having from about 1 to about 30 carbon atoms, wherein the aliphatic group can be branched or straight chained, saturated or unsaturated; and, R₆ is alkylene or hydroxyalkylene group with chain length from zero to about 6, wherein said zwitterionic viscoelastic surfactant is incorporated in an amount from about 0.5% to about 15% by weight based upon total fluid weight.

15. (canceled)

16. The method of claim 1 wherein said viscoelastic surfactant is an amphoteric surfactant represented by a formula: 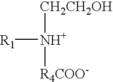
wherein R₁ is an alkyl, alkenyl, arylalkyl, or hydroxyalkyl group wherein each of said alkyl groups contain from about 8 to about 24 carbon atoms and may be branched or straight chained and saturated or unsaturated; and wherein R₄ is a hydrogen or an aliphatic chain having from about 1 to about 30 carbon atoms, wherein the aliphatic group can be branched or straight chained, saturated or unsaturated or an amphoteric surfactant represented by a formula: 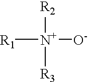
wherein R₁, R_{2,}and R₃ are alkyl, alkenyl, arylalkyl, or hydroxyalkyl groups wherein each of said alkyl groups contain from about 8 to about 24 carbon atoms and may be branched or straight chained and saturated or unsaturated, wherein said amphoteric viscoelastic surfactant is incorporated in an amount from about 0.5% to about 15% by weight based upon total fluid weight.

17. (canceled)

18. The method of claim 17 wherein said alcohol is selected from the group consisting of methanol and iso-propanol.

19. (canceled)

20. The method of claim 1 wherein said fluid further comprises a proppant or an additive selected from the group consisting of corrosion inhibitors, fluid-loss additives, and mixtures thereof.

21. (canceled)

22. The method of claim 1 wherein said fluid further comprises a gas component to provide a foam or energized fluid wherein said gas component comprises a gas selected from the group consisting of nitrogen, air, and carbon dioxide.

23. The method of claim 1 wherein said fluid further comprises a viscosifying agent selected from the group consisting of guar, guar derivatives, hydroxypropyl guar, carboxymethyl guar, carboxymethylhydroxypropyl guar, starch, starch derivatives, hydroxyethyl cellulose, carboxymethylhydroxyethyl cellulose, hydroxypropyl cellulose, xanthan, diutan, polyacrylates, polyDADMAC, clay, and mixtures thereof

24. A high pH fluid composition comprising a viscoelastic surfactant, a hydrolysable fiber and a pH control additive, wherein said viscoelastic surfactant is a cationic surfactant comprises a cationic surfactant having the structure:
R₁N⁺(R₂)(R₃)(R₄)X⁻
in which R₁ has from about 14 to about 26 carbon atoms and may be branched or straight chained, aromatic, saturated or unsaturated, and may comprise a carbonyl, an amide, a retroamide, an imide, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; and X⁻is an anion; and mixtures of these compounds, said fluid having an initial pH of at least about 10.

25. The fluid composition of claim 24 wherein said fluid has an initial pH of at least about 11.

26. The fluid composition of claim 24 wherein said viscoelastic surfactant is a zwitterionic surfactant represented by a formula: 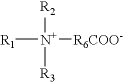
wherein R₁ is an alkyl, alkenyl, arylalkyl, or hydroxyalkyl group wherein each of said alkyl groups contain from about 8 to about 24 carbon atoms and may be branched or straight chained and saturated or unsaturated; and wherein R₂, and R₃ are independently a hydrogen or an aliphatic chain having from about 1 to about 30 carbon atoms, wherein the aliphatic group can be branched or straight chained, saturated or unsaturated; and, R₆ is alkylene or hydroxyalkylene group with chain length from zero to about 6, wherein said zwitterionic viscoelastic surfactant is incorporated in an amount from about 0.5% to about 15% by weight based upon total fluid weight.

27. (canceled)

28. The fluid composition of claim 24 wherein said viscoelastic surfactant is an amphoteric surfactant represented by a formula: 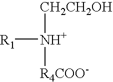
wherein R₁ is an alkyl, alkenyl, arylalkyl, or hydroxyalkyl group wherein each of said alkyl groups contain from about 8 to about 24 carbon atoms and may be branched or straight chained and saturated or unsaturated; and wherein R4 is a hydrogen or an aliphatic chain having from about 1 to about 30 carbon atoms, wherein the aliphatic group can be branched or straight chained, saturated or unsaturated, wherein said amphoteric viscoelastic surfactant is incorporated in an amount from about 0.5% to about 15% by weight based upon total fluid weight.

29. (canceled)

30. The method composition of claim 24 wherein said viscoelastic surfactant is an amphoteric surfactant represented by a formula: 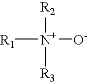
wherein R₁, R₂, and R₃ are alkyl, alkenyl, arylalkyl, or hydroxyalkyl groups wherein each of said alkyl groups contain from about 8 to about 24 carbon atoms and may be branched or straight chained and saturated or unsaturated.

31. A high pH well treatment fluid comprising a viscoelastic surfactant having a degradable linkage, a hydrolysable fiber and a pH control material wherein said fluid has an initial pH of at least about 10.

32. A well treatment fluid according to claim 31 wherein said viscoelastic surfactant contains an amide linkage.

33. A well treatment fluid according to claim 31 wherein the viscoelastic surfactant is represented by a formula:

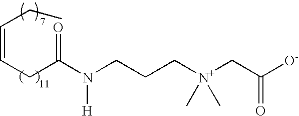

34. The fluid composition of claim 31 further comprising an alcohol selected from the group consisting of methanol and iso-propanol.

35. (canceled)

36. (canceled)

37. (canceled)

38. The fluid composition of claim 31 further comprising an additive selected from the group consisting of proppants, corrosion inhibitors, fluid-loss additives, and mixtures thereof.

39. The fluid composition of claim 31 further comprising a gas component to provide a foam or energized fluid wherein said gas component comprises a gas selected from the group consisting of nitrogen, air, and carbon dioxide.

40. The fluid composition of claim 31 further comprising a viscosifying agent selected from the group consisting of guar, guar derivatives, hydroxypropyl guar, carboxymethyl guar, carboxymethylhydroxypropyl guar, starch, starch derivatives, hydroxyethyl cellulose, carboxymethylhydroxyethyl cellulose, hydroxypropyl cellulose, xanthan, diutan, polyacrylates, polyDADMAC, clay, and mixtures thereof.
